(19) United States
(12) Patent Application Publication
(10) Pub. No.: US 2005/0217032 A1
(43) Pub. Date: Oct. 6, 2005

(54) Multi-purpose hand-held device

(76) Inventor: Beatrice Bruggisser, Kusnacht (CH)

Correspondence Address: Brinks Hofer Gilson & Lione, P O Box 10395, Chicago, IL, 60610, US

(21) Appl. No.: 10/505,972

(22) PCT Filed: Mar. 5, 2003
(86) PCT No.: PCT/EP03/02227

§ 371 Date: Aug. 25, 2004

(30) Foreign Application Priority Data
Mar. 6, 2002 (DE) 102 09 748.8

(51) Int. Cl. B26B 11/00

(52) U.S. Cl. 7/119

(57) ABSTRACT

The invention relates to a multipurpose hand-held implement having a first component (1) and a second component (2) which are connected to one another for pivoting action about a pin (3) and can be moved between a first position, in which they form, together, an elongate body, and a second position, in which they form a free space for material which is to be stapled, one component (1) comprising a staple magazine (4) and a top part (10) with a staple driver (5) and the other component (2) comprising an anvil (6), and a roll-up measuring tape (23) being arranged in the body with its winding spindle (24) parallel to the pin (3), and adjacent to the latter, such that it can be pulled out on that end side of the body which is located adjacent to the pin (3).

The invention relates to a multipurpose hand-held implement according to the preamble of claim 1.

Such multipurpose hand-held implements with a stapler and a roll-up measuring tape are known from WO 97/04924, the roll-up measuring tape being arranged in a plane parallel to the bearing platform of the stapler for material which is to be stapled and taking up a corresponding amount of space, which is then not available for additional swing-out tools such as scissors, a knife blade, magnifier glass or the like.

The object of the invention is to provide a multipurpose hand-held implement according to the preamble of claim 1 which makes it possible to accommodate a roll-up measuring tape in an area which detracts as little as possible from the rest of the functions.

This object is achieved in accordance with the characterizing part of claim 1.

Further configurations of the invention can be gathered from the following description and the subclaims.

The invention is explained in more detail hereinbelow with reference to exemplary embodiments illustrated in the attached figures, in which:

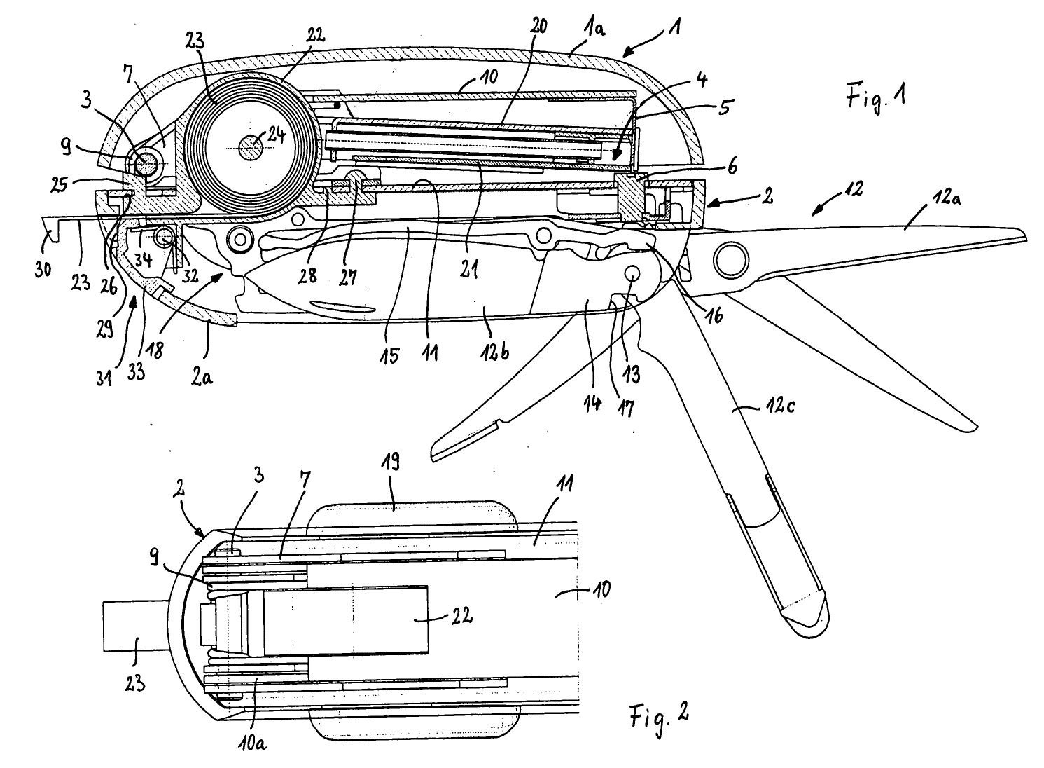

FIG. 1 shows, in section, an embodiment of a multipurpose hand-held implement having two components in the closed position with tools partially swung out,

FIG. 2 shows a plan view of the top, uncovered component of the multipurpose hand-held implement,

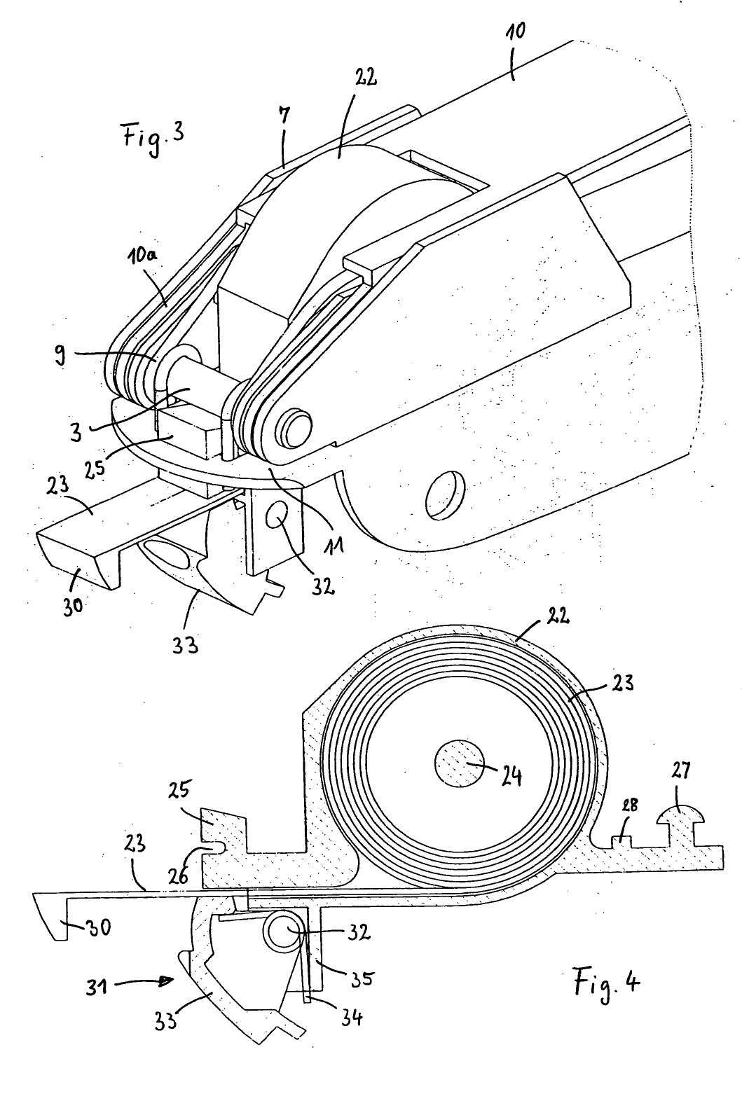

FIG. 3 shows a perspective view, in detail form, of an articulation region of the components of the multipurpose hand-held implement from FIG. 1,

FIG. 4 shows, in section, a roll-up-measuring-tape installation module for the multipurpose hand-held implement from FIG. 1,

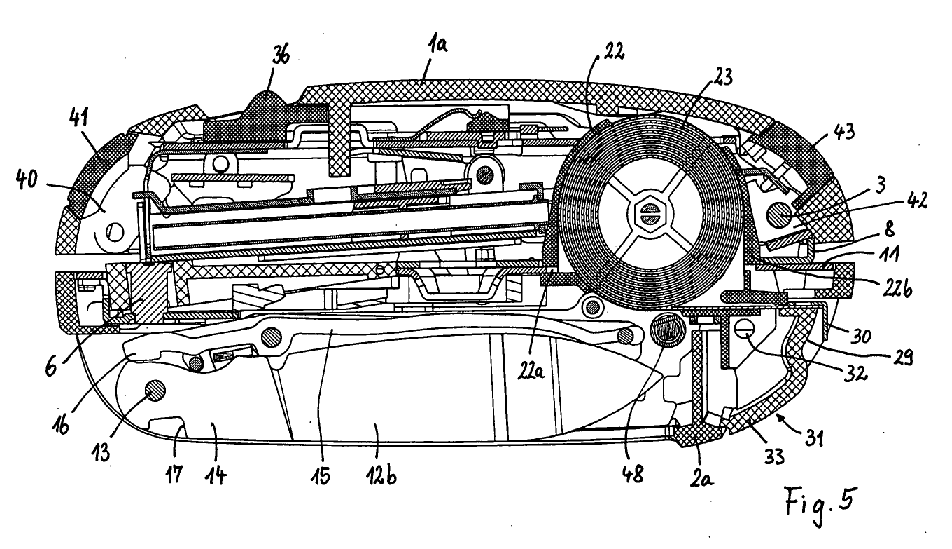

FIG. 5 shows, in section, a further embodiment of a multipurpose hand-held implement having two components in the closed position and tools swung in,

FIGS. 6 to 9 show perspective views, some in detail form, of components of the multipurpose hand-held implement from FIG. 5, and

FIG. 10 shows a perspective view, in detail form, of a further embodiment of the multipurpose hand-held implement from FIG. 5.

The multipurpose hand-held implement illustrated, which serves, in particular, for carrying out office work and comprises a stapler, has a first component 1 and a second component 2 which are connected to one another for pivoting action about a pin 3. The first component 1 comprises a stapler magazine 4 and a top part 10 with a stapler driver 5, while the second component 2 has an anvil 6 for folding over ends of ejected staples during the stapling operation.

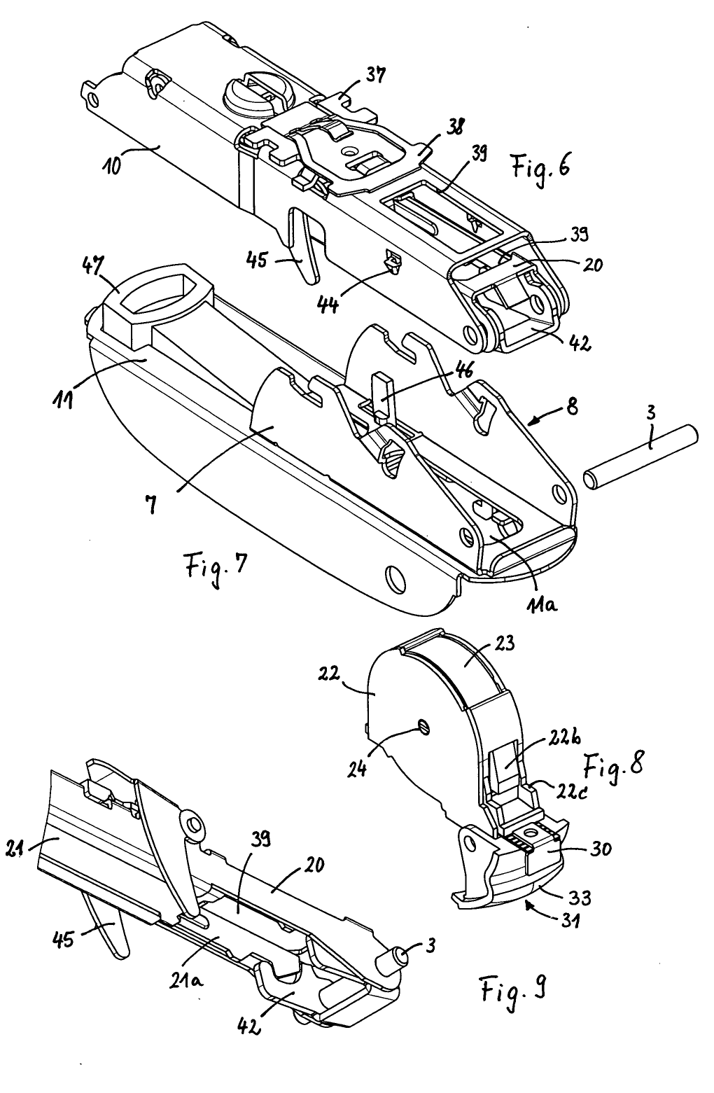

The two components 1, 2, each provided with a respective outer shell 1a, 2a, can be moved between a closed position, in which they form, together, an elongate, essentially closed body, and a second, open position, in which they are arranged at an angle in relation to one another to form a free space for the introduction of material which is to be stapled. The movement from the open position into the closed position takes place about the pin 3, which is mounted in lateral legs 7 of a U-shaped bearing block 8 (which can best be seen in FIG. 7) borne by the bottom component 2, and counter to the force of two clip springs 9, which are positioned around the pin 3 and have their legs supported, on the one hand, on the bottom component 2 and, on the other hand, on the top part 10, which bears the staple driver 5.

A manually releasable locking mechanism (not illustrated) may be provided in order to retain the two components 1, 2 in the position illustrated in FIG. 1 and/or, following release from this position, to allow these two components to pivot into the open position.

Such a multipurpose hand-held implement is illustrated and described, for example, in WO 97/04924.

The bottom component 2 is covered in the direction of the top component 1 by a base plate 11 into which the clip springs 9 are fitted and which accommodates the anvil 6.

Moreover, additional swing-out tools 12, for example scissors 12a, a knife blade 12b and a staple remover 12c, are arranged in an outwardly open accommodating space of the bottom component 2. The swing-out tools 12 have shanks 14 which can be rotated about a common pivot pin 13 and are each subjected to the action of a leaf spring 15, with the result that the swing-out tools 12 are prestressed into the swung-in position and are latched in a manually releasable manner in the swung-out position by virtue of a head 16 of the leaf spring 15 being latched into a cutout 17 of the shank. In the swung-out position, the two components 1, 2, in the closed state illustrated in FIG. 1, serve as a handle for the respective swing-out tool 12.

A lifting mechanism 18, which can be actuated via levers 19 fitted laterally on the bottom component 2, serves for raising the swing-out tools 12 some way counter to the force of the leaf springs 15, with the result that they are easier to grip and swing out.

A multipurpose hand-held implement having swing-out tools and a lifting mechanism is illustrated and described, for example, in WO 99/20438.

The top part 10 is forked in the rear portion and articulated on the pin 3 such that it can be pivoted via legs 10a. The staple magazine 4, furthermore, comprises an outer channel 20, which is likewise forked and can be pivoted about the pin 3. The outer channel 20 serves for accommodating a staple carrier 21, which accommodates a block of staples which is pushed against a front wall of the staple carrier 21 by means of a spring-activated slide (not illustrated). The staple carrier 21 has, in the direction of the anvil 6, a slot through which a staple can pass out under the action of the staple driver 5, upon actuation of the stapler, in order then to be folded over by the anvil 6.

A roll-up measuring tape 23 is fastened on the base plate 11 approximately centrally in relation to the longitudinal axis of the implement, the measuring tape being arranged in a housing 22 and being wound up about a winding spindle 24 which runs parallel to the pin 3. In the exemplary embodiment illustrated, the base plate 11 is provided with a cutout 11a and the housing 22, on the one hand, is fitted into the base plate 11 via a hook-like extension 25 with a groove 26 and, on the other hand, is fastened on the base plate 11 by means of at least one rivet 27 which extends through the base plate 11 and the bearing block 8. (Instead of the at least one rivet 27, it is also possible to provide a snap-action catch.) The housing 22, which may additionally have a stop 28 for positioning in the cutout of the base plate 11, is located between the clip springs 9, the forked portions of the top part 10, of the outer channel 20 and of the staple carrier 21 and between the legs 7 of the bearing block 8, and projects beneath the shell la of the top component 1, with the result that the space beneath the base plate 11 is essentially not occupied by the housing 22. Depending on the arrangement of the swing-out tools 12, it is possible to arrange the housing 22 wholly or partially beneath the base plate 11 or on the first component 1.

In the case of the exemplary embodiment illustrated, the roll-up measuring tape 23 is guided out of the bottom component 2, essentially parallel to the base plate 11, via a central slot on the end side which is located opposite the anvil 6. The roll-up measuring tape 23 can also be guided out of the bottom component 2 in a state in which it is offset, for example, through 90°. The bottom component 2 has an access hollow 29 for accommodating and for gripping an angled, thickened end part 30 of the roll-up measuring tape 23.

In addition, a brake 31 is expediently provided for the roll-up measuring tape 23. The brake 31 comprises a button 33 which is arranged for pivoting action about a pin 32. The button 33 is pushed against the roll-up measuring tape 23 by a leg spring 34 which is positioned around the pin 32 and is supported, on the one hand, on the button 33 and, on the other hand, on a leg 35 of the housing 22. Corresponding actuation of the button 33 counter to the force of the leg spring 34 releases the roll-up measuring tape 23 in order to be pulled out or automatically rolled in. In the present exemplary embodiment, the button 33 is provided with the access hollow 29.

The housing 22 with the roll-up measuring tape 23 and, if appropriate, the brake 31 is expediently a prefabricated module which is used as such and is fastened on the base plate 11, it being possible for the roll-up measuring tape 23 to be located, with its housing 22, in the top and/or bottom component 1, 2.

In the case of the exemplary embodiment which is illustrated in FIGS. 5 to 9, the housing 22 for the roll-up measuring tape 23 forms a ready-to-install subassembly together with the brake 31, the brake 31 being retained on the housing 22 via the pin 32 (the spring 34 not being illustrated here). The resulting unit is inserted from beneath into a corresponding cutout 11a of the base plate 11, which bears the bearing block 8. In this case, as can be seen from FIG. 5, the border of the base plate 11 is accommodated in the housing 22 in the inward direction by a slot 22a, whereupon the housing 22 is pushed upwards, with the result that the opposite border of the base plate 11 latches in between a ramp-like protrusion 22b and a step 22c on the housing 22. The bearing block 8, which is fastened on the base plate 11, is expediently provided with a cutout which is somewhat larger than the cutout 11a in the base plate 11, with the result that the housing 22 merely grips the border of the latter. For space-related reasons, the housing 22 may be provided with an opening 23 on the top side.

It is also the case in this exemplary embodiment that the top part 10, the outer channel 20 and the staple carrier 21 are provided with through-passage openings 39 for the housing 22.

FIG. 5 shows the implement in the closed state. In order to open the implement, i.e. in order to pivot the two components 1, 2 about the pin 3, a button 36 which latches in a latching spring 38 can be displaced on the top side of the component 1. As a result, a closing plate 37 (FIG. 6) which is coupled to the button 36, is displaced in relation to the top part 10, which is located in the component 1 and can be pivoted about the pin 3, from a locking position into an opening position, with the result that an introduction slot for material which is to be stapled is opened in a mouth-like manner between the two components 1, 2.

That part of the stapler which comprises the staple magazine 4, the staple driver 5, the outer channel 20 and the staple carrier 21 and is accommodated by the top part 10 is retained in the inactive position in the top part 10 by a locking means 40. It is possible to release the locking means 40, and thus activate the stapler, via a button 41.

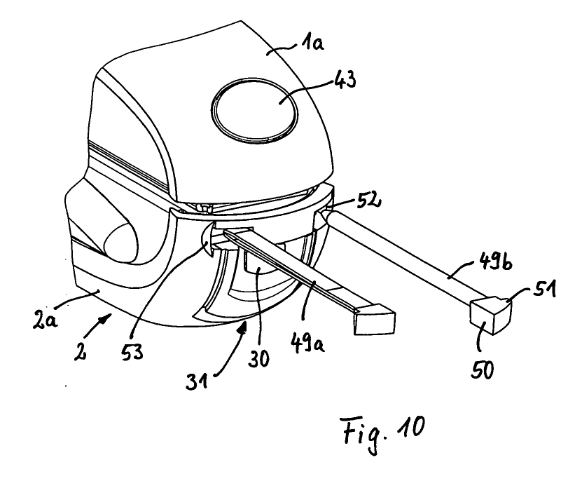

The top part 10 accommodates the outer channel 20 of the stapler and a trigger 42, which can both likewise be pivoted about the pin 3, it being possible for the trigger 42 to be pivoted via a button 43, by virtue of the latter being pushed in, into a position in which the staple carrier 21, which is retained by the trigger 42 via fork ends 21a (see FIG. 9), is released and (with the stapler activated) can be moved under a spring force into an extended position, with the result that a new block of staples can be introduced.

The top part 10 has its opening angle limited via stops 44 on the bearing block 8. Located on the outer channel 20 are transmission levers 45 which interact with slides 46, which can be displaced in relation to the base plate 11, during stapling, i.e. during closure of the introduction slot between the two components 1, 2, in order to form a so-called flat-clinch mechanism. As a result, a paper rest 47, which cannot be seen in the embodiment of FIG. 1, is retained in its position illustrated in FIG. 7 until such time as the staple has pierced the material which is to be stapled, whereupon further movement of the transmission lever 45 causes the paper rest 47 to move downwards, in order to bring the anvil 6 into effect.

In the case of both exemplary embodiments, the tools 12a to 12c can be inserted into the implement as a module with a corresponding raising mechanism for raising the tools 12a to 12c into an easy-to-grip position, it being possible for this mechanism to be actuated via levers 19 (FIG. 2) (not illustrated) which act on a pin 48.

In the case of the embodiment which is illustrated in FIG. 10, a further, removable utensil 49a, 49b is arranged on both sides of the housing 22 of the roll-up measuring tape 23, in each case in a shaft of the component 2. These utensils are constituted, in particular, by a pair of tweezers (utensil 49a) and a pen or pencil (utensil 49b). The two utensils 49a, 49b are provided with heads 50 on which in each case one outwardly directed nose 51 is arranged. The heads 50 are accommodated in a flush manner in the outer shell 2a by corresponding cutouts 52 provided on the end side of the body, notches 53 being arranged adjacent to the cutouts 52 in order for it to be possible to use a finger nail to act on the respective nose 51 for the removal of the utensil 49a, 49b and to pull the latter out on the end side.

1. Multipurpose hand-held implement having a first component and a second component which are connected to one another for pivoting action about a pin and can be moved between a first position, in which they form, together, an elongate body, and a second position, in which they form a free space for material which is to be stapled, one component comprising a staple magazine and a top part with a staple driver and the other component comprising an anvil, and a roll-up measuring tape being arranged in the body such that it can be pulled out, wherein the roll-up measuring tape is arranged with its winding spindle parallel to the pin, and adjacent to the latter, and can be pulled out on that end side of the body which is located adjacent to the pin.

2. The multipurpose hand-held implement of claim 1, wherein the roll-up measuring tape is arranged behind the staple magazine.

3. The multipurpose hand-held implement of claim 1 or 2, wherein the roll-up measuring tape is arranged in a housing.

4. The multipurpose hand-held implement of claim 1 or 2, wherein an outer channel, which accommodates a staple carrier, and the top part, which bears the staple driver, are forked or provided with a through-passage opening adjacent to the pin and accommodate the roll-up measuring tape in the region of the forking or through-passage opening.

5. The multipurpose hand-held implement of claim 4, wherein the outer channel and the top part are mounted together on the pin.

6. The multipurpose hand-held implement of claim 1, wherein the component, which bears the anvil, comprises a U-shaped bearing block which accommodates the pin.

7. The multipurpose hand-held implement of claim 1, wherein a clip spring is arranged laterally in relation to the roll-up measuring tape, is supported on the top part and on the component, which accommodates the anvil, and biases the components into the second position.

8. The multipurpose hand-held implement of claim 7, wherein two clip springs are provided, the roll-up measuring tape being arranged between them.

9. The multipurpose hand-held implement of claim 7 or 8, wherein the clip spring is supported on a base plate of the component, which accommodates the anvil.

10. The multipurpose hand-held implement of claim 3, wherein the component, which accommodates the anvil, bears the housing, and the roll-up measuring tape is guided out of this housing via an end-side outlet opening.

11. The multipurpose hand-held implement of claim 10, wherein the component, which accommodates the anvil, has a base plate on which the housing is fastened.

12. The multipurpose hand-held implement of claim 11, wherein the housing is fitted into a cutout of the base plate and is additionally riveted or latched.

13. The multipurpose hand-held implement of claim 1, wherein the roll-up measuring tape is guided out of the components, which accommodates the anvil, through a slot at that end of the component which is located opposite the anvil.

14. The multipurpose hand-held implement of claim 1, wherein a brake is provided for the roll-up measuring tape.

15. The multipurpose hand-held implement of claim 14, wherein the brake comprises a button which is biased against the roll-up measuring tape via a spring.

16. The multipurpose hand-held implement of claim 14 or 15, wherein the brake forms a subassembly with the housing.

17. The multipurpose hand-held implement of claim 10, wherein the component, which accommodates the anvil, accommodates swing-out tools on the end side which is located opposite the outlet opening of the roll-up measuring tape.

18. The multipurpose hand-held implement of claim 4, wherein the staple carrier is forked in the region of the roll-up measuring tape, the fork ends being fitted in a trigger arranged behind the roll-up measuring tape.

19. The multipurpose hand-held implement of claim 1, wherein at least one shaft for accommodating a utensil is arranged in the second component, laterally in relation to the roll-up measuring tape, wherein the utensil can be pulled out of the component on the end side.

20. The multipurpose hand-held implement of claim 19, wherein the at least one shaft is provided on both sides of the roll-up measuring tape.

21. The multipurpose hand-held implement of claim 19 or 20, wherein the utensil is a pair of tweezers.

22. The multipurpose hand-held implement of claim 19, wherein the utensil is selected from the group consisting of a pen or pencil.
